(19) United States
(12) Patent Application Publication
(10) Pub. No.: US 2010/0015270 A1
(43) Pub. Date: Jan. 21, 2010

(54) INNER CAVITY SYSTEM FOR NANO-IMPRINT LITHOGRAPHY

(75) Inventors: Byung-Jin Choi, Austin, TX (US); Kosta S. Selinidis, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/498,748

(22) Filed: Jul. 7, 2009

Related U.S. Application Data
(60) Provisional application No. 61/080,890, filed on Jul. 15, 2008.

(51) Int. Cl. B29C 59/02

(52) U.S. Cl. 425/149; 425/385

(57) ABSTRACT

A nano-imprint lithography template system having a support layer with at least one port, and a patterned surface layer coupled to the support layer. Coupling of the patterned surface layer to the support layer forms a cavity. Pressure within the cavity is controlled through the port of the support layer.

### CROSS-REFERENCE TO RELATED APPLICATIONS

This application claims the benefit under 35 U.S.C. § 119(e)(1) of U.S. Provisional No. 61/080,890, filed on Jul. 15, 2008, which is hereby incorporated by reference herein.

### STATEMENT REGARDING FEDERALLY SPONSORED RESEARCH OR DEVELOPMENT

The United States government has a paid-up license in this invention and the right in limited circumstances to require the patent owner to license others on reasonable terms as provided by the terms of SPAWAR N66001-06-C-2003 Nanoimprint Lithography Manufacturing Scale (NIMS) Award and NIST ATP AWARD 70NANB4H3012.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference herein.

An imprint lithography technique disclosed in each of the aforementioned U.S. patent publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with an embodiment of the present invention.

FIG. 2 illustrates a simplified side view of the substrate shown in FIG. 1 having a patterned layer positioned thereon.

FIG. 3A illustrates a simplified side view of an embodiment of a template system.

FIG. 3B illustrates a simplified side view of another embodiment of a template system.

FIGS. 4A and 4B illustrate top down views of exemplary template systems.

FIG. 5A illustrates a simplified side view of Portion A and Portion B forming a template system.

FIG. 5B illustrates a simplified side view of Portion C and Portion D forming another template system.

### DETAILED DESCRIPTION

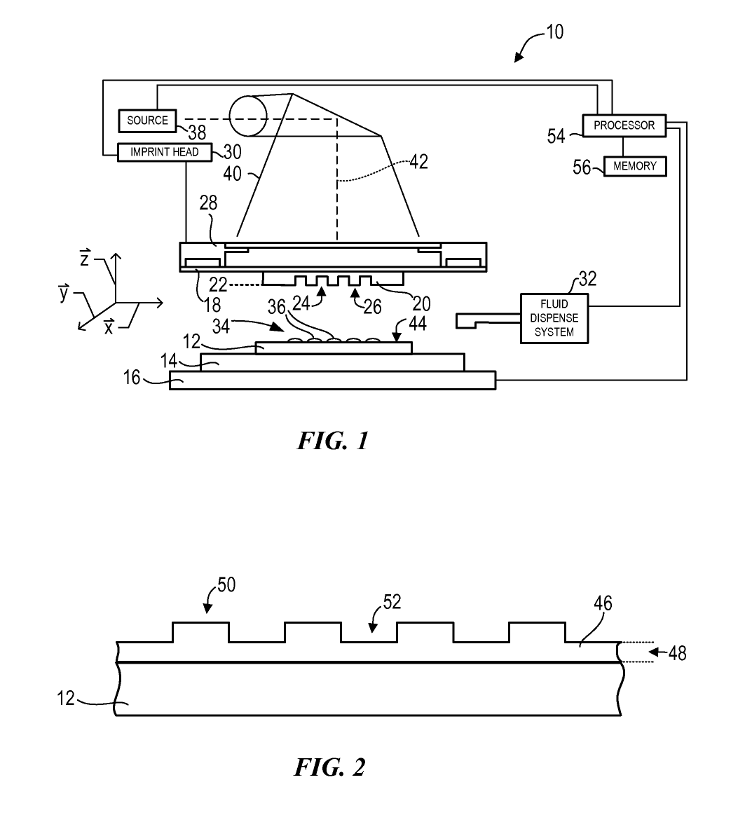

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide translation and/or rotational motion with respect to the x, y, and z axes. Stage 16, substrate 12, and substrate chuck 14 may also be positioned on a base (not shown).

Spaced-apart from substrate 12 is template 18. Template 18 may include mesa 20 extending therefrom towards substrate 12, mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. For example, polymerizable material 34 may be positioned upon substrate 12 using techniques such as those described in U.S. Patent Publication No. 2005/0270312 and U.S. Patent Publication No. 2005/0106321, both of which are hereby incorporated by reference herein. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Publication No. 2005/0187339, both of which are hereby incorporated by reference herein.

Referring to FIGS. 1 and 2, system 10 may further comprise energy source 38 coupled to direct energy 40 along path 42. Imprint head 30 and stage 16 may be configured to position template 18 and substrate 12 in superimposition with path 42. System 10 may be regulated by processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., ultraviolet radiation, causing polymerizable material 34 to solidify and/or cross-link conforming to a shape of surface 44 of substrate 12 and patterning surface 22, defining patterned layer 46 on substrate 12. Patterned layer 46 may comprise a residual layer 48 and a plurality of features shown as protrusions 50 and recessions 52, with protrusions 50 having a thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, all of which are hereby incorporated by reference herein.

A standard template 18, as illustrated in FIG. 1, may be nominally 0.25″ in thickness. This magnitude of thickness may provide minimal bending at the surface of template 18 (e.g., surface of mold 20). As the rigid surface comes into contact with polymerizable material 34, pockets of gas may become entrapped. These pockets generally must be displaced prior to solidification of polymerizable material 34, thus, slowing the imprinting process.

A template design for correcting such deficiencies is proposed in related U.S. Patent Publication No. 2008/0160129, which is hereby incorporated by reference herein in its entirety. This template design may improve filling speed by flexing of a thin patterned layer. For example, the design includes a hollow center that may allow for a flexible surface. The hollow center may reduce the stiffness of the design, yet may be susceptible to alignment and overlay issues resulting from out-of-plane bending and/or actuator compression errors. These issues may result in a non-uniform thickness t₂ of residual layer 48 (shown in FIG. 2), with such variations in thickness t₂ adding to non-correctible distortion and/or compromising overlay capability.

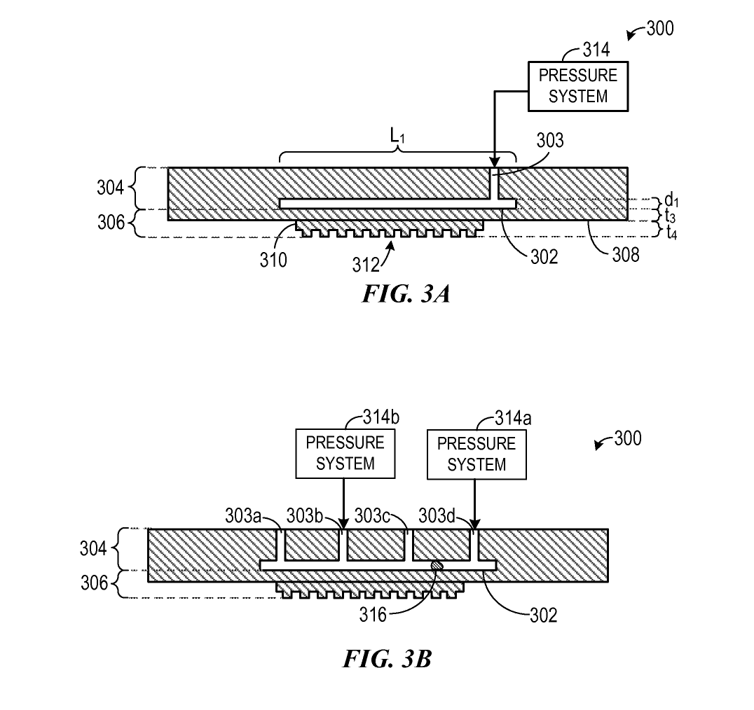

Referring to FIGS. 3A and 3B, a template system 300 having an inner cavity 302 and flexibility may increase filling speed of polymerizable material 34 while still providing stiffness for overlay and/or alignment during imprinting as described above with respect to FIGS. 1 and 2. Such flexibility combined with stiffness with the design of template system 300 may increase throughput and/or improve alignment/overlay in nano-imprint applications. Additionally, such a design may be implemented into form factors including, but not limited to, stand 65 mm square template form factor, 6025 photomask form factor, and/or the like.

Referring to FIG. 3A, template system 300 may generally comprise an inner cavity 302, a support layer 304, and a patterned surface layer 306. Template system 300 may also include one or more cavity ports 303. For example, template system 300 of FIG. 3A includes cavity port 303. Template system 300 of FIG. 3B includes cavity ports 303a-d.

Patterned surface layer 306 may comprise a thin flexible base 308, a mesa region 310 (corresponding to mesa 20 of FIG. 1), and a relief image 312. Flexible base 308 may have a thickness t₃, and may be formed from such materials including, but not limited to, fused-silica, quartz, silicon, organic polymers, siloxane polymers, borosilicate glass, fluorocarbon polymers, metal, hardened sapphire, and/or the like. For example, flexible base 308 may be formed from fused silica and have a magnitude of thickness t₃ of approximately 0.2 mm to 3 mm.

Mesa region 310 may have a thickness t₄, and may be formed of materials similar to flexible base 308. For example, mesa region 310 may be formed of fused silica having a magnitude of thickness of approximately 5 to 200 μm. Relief image 312 may extend from the surface of mesa region 310 and/or relief image 312, or portions of relief image 312, may be recessed into the surface of mesa region 310. Relief image 312, or portions of relief image 312, may be used to form the corresponding pattern in patterned layer 46, such as illustrated and described with respect to FIG. 2.

Inner cavity 302 may include a volume between support layer 304 and patterned surface layer 306. The volume may include a distance d₁ between support layer 304 and patterned surface layer 306. For example, distance d₁ may be approximately 0.010 mm to 5 mm depending on design considerations. Additionally, the volume of space forming cavity 302 may include a length L₁. For example, length L₁ may be substantially similar to or larger than the length of patterned mesa region 310, the length of support layer 304, and/or other range depending on design considerations.

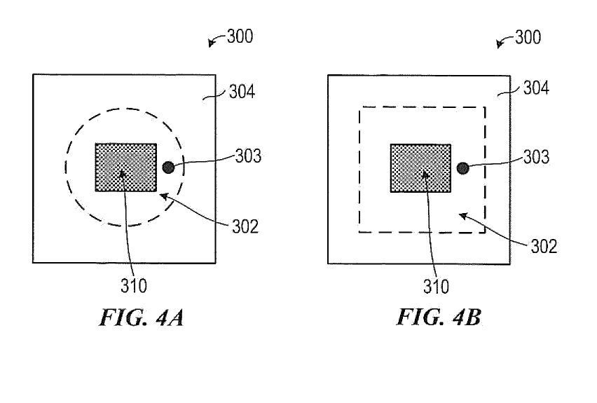

Referring to FIGS. 4A and 4B, inner cavity 302 may have a variety of shapes including, but not limited to, circular, oval, rectangular, square, or any other fanciful shape. For example, FIG. 4A illustrates inner cavity 302a having a circular shape, and FIG. 4B illustrates inner cavity 302b having a square shape.

Referring again to FIGS. 3A and 3B, pressure within inner cavity 302 may be controlled through cavity access port 303. For example, pressure within inner cavity may be controlled through cavity access port 303 by pressure system 314. Pressure system 314 may include, but is not limited to, a pressurized chamber, vacuum pump, or other similar means that may be coupled to port 303 to control pressure within cavity 302.

Applied pressure in cavity 302 provided by pressure system 314 may be used to flex and/or bow patterned surface 306. For example, pressure applied by pressure system 314 into cavity 302 may be in the ragne of −100 kPa to 100 Kpa. Additionally, pressure within the cavity 302 may be controlled by a precision pressure regulator. Pressure may be increased or decreased depending on use (e.g., flexing and/or bowing) of template system 300. During application of pressure within cavity 302, support layer 304 may provide stiffness within template system 300 through material and/or thickness design. Such stiffness, during application of pressure within cavity 302, may provide control of overlay and/or alignment of template system 300. For example, stiffness of support layer 304 may provide control of overlay and/or alignment of template system 300 during flexing and/or bowing of patterned surface 306 resulting from application of pressure within cavity 302.

Pressure may be controlled using multiple pressure systems 314a and 314b as illustrated in FIG. 3B. Although two pressure systems 314a and 314b are illustrated, it should be noted that any number of pressure systems 314a may be coupled to one or more ports 303a-d. For example, each port 303a-d may be coupled to a separate pressure system 314. Alternatively, multiple ports 303a-d may be coupled to shared pressure systems 314. The number and coupling of pressure systems 314 to ports 303 may be based on design considerations. For example, as illustrated in FIG. 3B, port 303b may be coupled to pressure system 314b and port 303d may be coupled to pressure system 314a. With use of two pressure systems 314a and 314b, a particle 316 within cavity 302 may be extracted by application of positive pressure and vacuum pressure supplied by pressure systems 314a and 314b. For example, pressure system 314a may apply a positive pressure while pressure system 314b applies vacuum pressure to extract particle 316 from cavity 302.

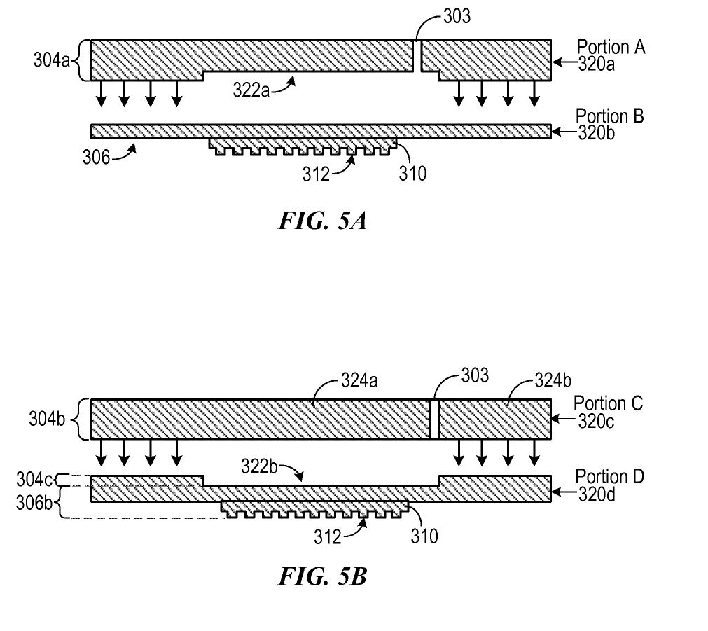

FIGS. 5A and 5B illustrate formation of template systems 300a and 300b through coupling of multiple portions 320 to fabricate template system 300a and/or 300b.

Referring to FIG. 5A, Portion A 320a may include support layer 306 and a recess 322a that when coupled to Portion B 320b forms inner cavity 302 (shown in FIG. 3A). Portion B 320b may include patterned surface layer 306a and Portion A 320a may include support layer 304a. Portion A 320a and/or recess 322a may be formed by a variety of methods including, but not limited to, machining, lithographic patterning, etching, and/or the like. Similarly, Portion B 320b may be fabricated by a variety of methods including, but not limited to, machining, lithographic patterning, standard wafer processes, and the like. Coupling of Portion A 320a to Portion B 320b may be through a variety of methods including, but not limited to, anionic bonding, adhesives (e.g., thin adhesives), thermal welding, and the like.

FIG. 5B illustrates another embodiment of formation of template 300 through coupling of Portion C 320c and Portion D 320d. In this embodiment, Portion C 320c may include a first portion of support layer 304b. Portion D 320d may include a second portion of support layer 304c in addition to recess 322b and patterned surface layer 306b. Coupling of Portion C 320c to Portion D 320d having a recess forms inner cavity 302 (shown in FIG. 3A). In addition, Portion C 320c may be formed of two sub-portions 324a and 324b as illustrated in FIG. 5B. Sub-portions 324a and 324b may be formed separately such that when sub-portions 324a and 324b are coupled, together sub-portions 324a and 324b form port 303. It should be noted, port 303 may be formed through a variety of processes including, but not limited to machining, lithographic patterning, etching, and the like, without coupling of sub-portions 324a and 324b.

What is claimed is:

1. A nano-imprint lithography template system, comprising:
a support layer having at least one port;
a patterned surface layer coupled to the support layer such that a cavity is formed between the support layer and the patterned surface layer, wherein pressure within the cavity is controlled through the port of the support layer.

2. The template of claim 1, wherein the support layer has multiple ports, within each port controlling the pressure within the cavity.

3. The template of claim 2, wherein the multiple ports distribute pressure within the cavity.

4. The template of claim 2, wherein at least one port provides vacuum pressure and at least one port provides positive pressure.

6. The template of claim 1, wherein the cavity is rectangular.

7. The template of claim 1, wherein the port of the support layer provides pressure to the cavity such that patterned surface layer is flexed.

8. The template of claim 7, wherein the magnitude of thickness of the support layer and materiality of the support layer provides stiffness to the template system to minimizes alignment error.

9. The template of claim 1, wherein the patterned surface layer includes a flexible base, a mesa region and a relief image, the flexible base being coupled to the support layer.

10. The template of claim 9, wherein the relief image extends from a surface of the mesa region.

11. The template of claim 9, wherein a length of cavity is larger than a length of mesa region.

12. The template of claim 1, wherein the patterned surface layer is bonded to the support layer.

13. The template of claim 12, wherein the patterned surface layer includes a recess forming the cavity.

14. The template of claim 1, wherein the cavity and the port are formed through hollowing the support layer and the patterned surface layer.

15. A nano-imprint lithography template system, comprising:
a first portion having at least one port and at least one recess;
a second portion coupled to the first portion such that the recess of the first portion forms a cavity between the first portion and the second portion, wherein pressure within the cavity is controlled by the port of the first portion.

16. The template of claim 15, wherein the first portion of the template is bonded to the second portion of the template.

17. The template of claim 15, wherein the port is formed within the first portion of the template by lithographic patterning.

18. The template of claim 15, wherein pressure within the cavity provides the second portion of the template in a flexed position.

19. The template of claim 18, wherein the first portion of the template has a magnitude of thickness and a materiality minimizing alignment error due to flexing of the second portion of the template.

20. A nanoimprint lithography template system, comprising:
a first portion of the template having a patterned surface layer and a recess;
a second portion of the template having a support layer coupled to the patterned surface layer such that the recess of the first portion forms a cavity between the first portion of the template and the second portion of the template, the support layer forming a port; and,
a pressure system coupled to the port to control pressure within the cavity.

21. The template of claim 4, wherein the vacuum pressure and the positive pressure control bowing of at least a portion of the patterned surface layer.
